(19) United States
(12) Patent Application Publication
(10) Pub. No.: US 2013/0117308 A1
(43) Pub. Date: May 9, 2013

(54) Apparatus, Method and System for Node Discovering

(71) Applicant: Jouni Korhonen, Fiihimaki (FI)

(72) Inventor: Jouni Korhonen, Fiihimaki (FI)

(73) Assignee: NOKIA SIEMENS NETWORKS OY, Espoo (FI)

(21) Appl. No.: 13/809,187

(22) PCT Filed: Jun. 7, 2011
(86) PCT No.: PCT/EP2011/059322

§ 371 Date: Jan. 9, 2013

(30) Foreign Application Priority Data
Jul. 9, 2010 (EP) PCT/EP2010/059909

(51) Int. Cl. G06F 17/30

(52) U.S. Cl. CPC G06F 17/30283
USPC 707/770

(57) ABSTRACT

A node discovery mechanism is described. The mechanism includes determining if an entry relating to a desired service is found in a table stored in a node;

performing a hash transform to a pair of data including a domain name and an application identifier relating to the desired service to obtain a key if the entry is not found in the table; sending a query including the obtained key to an overlay network, wherein the node is either part of the overlay network or connected to the overlay network through a proxy or an agent; obtaining a data object associated with the key from the overlay network; updating the table based on the data object.

### FIELD OF THE INVENTION

The invention addresses routing of Diameter messages, for example for use in large Authentication, Authorization and Accounting (AAA) infrastructure deployments using overlay networks for dynamic agent discovery.

### BACKGROUND OF THE INVENTION

Large Diameter based AAA infrastructures are being deployed, for example, for 3GPP Rel-8 LTE (Long Term Evolution) roaming networks. Diameter based protocols are being used in the infrastructures, which are intended to provide an AAA framework for applications such as network access or IP mobility. Diameter node is also intended to work in local authentication, authorization & accounting and roaming situations. The detailed description of such protocol can be found from RFC 3588.

Large Diameter infrastructures normally consist of multiple Diameter nodes, providing various kinds of applications and spanning over multiple realms. They are hard to manage when using manual AAA routing configuration. Large manually administrated infrastructures are a big burden to maintain and are prone to configuration errors.

Prior art solution in RFC3588 already describes a Domain Name System (DNS) based solution for dynamic Diameter server discovery. However, such DNS-based approach has a few known issues:

The DNS-based discovery is not aware of applications, which makes the discovery inefficient if a queried realm has deployed multiple agents that have different sets of applications.

Geographical information of Diameter nodes can not be traced in the DNS-based agent discovery method. Such information may be useful when considering load balancing issues and optimizing routing path in view of billing scheme provided by operators. As stated before, maintaining up-to-date AAA routing information can be an issue for big operators, especially when the number of Diameter nodes and applications grow. Moreover, DNS-based server discovery method only works properly in inter-realm cases. It does not really work within one realm, for example, one Diameter node cannot find or even does not attempt to dynamically find another Diameter node located within the same realm.

An IETF draft (http://tools.ietf.org/html/draft-ietf-dime-extended-naptr-01#page-4) provides an extension to RFC3588 that allows embedding application information to the DNS-based agent discovery. The extended format of Name Authority Pointer (NAPTR) provides a mapping from a domain to the service (SRV) record for contacting a server supporting a specific transport protocol and Diameter application. The resource record will contain an empty regular expression and a replacement value, which points to a SRV record for that particular transport protocol. Alternatively the NAPTR points to a A/AAAA (A ==IPv4 address, AAAA ==IPv6 address) record naming specific agent. If a Diameter node supports multiple transport protocols, there will be multiple NAPTR records, each with a different service field value and potentially different list of supported Diameter applications. The pre-condition for this mechanism to work is that the DNS administrator of the queried domain has already provisioned the DNS with extended format NAPTR entries.

However this solution still requires the presence of DNS and also greatly increases the DNS administration tasks. Moreover, the said solution is still designed to work in inter-realm cases.

A solution to overcome these problems should ideally fulfill at least some of the following criteria. A Diameter based infrastructure should not be centrally managed; instead it should have the self-organizing capability. The solution should be independent of any existing or future Diameter application. It should be robust when infrastructure changes with minimum disruption in service and routing functionality. In particular, it is important that the network is resilient when constituent node dies or a new node joins the network.

Moreover, the network should not require bilateral updates between realms due to any update in a peer agent of other realm. The solution should function in both single realm and inter-realm situation.

It is an object of the invention to provide a solution to overcome the above-mentioned problems and also to fulfill the above requirements.

### SUMMARY OF THE INVENTION

The present invention and its embodiments seek to address one or more of the above-described drawbacks and shortcomings.

According to a exemplary first aspect of the invention, there is provided a method for node discovery. The method comprises determining if an entry relating to a desired service is found in a table stored in a first node; performing a hash transform to a pair of data comprising a domain name and an application identifier relating to the desired service to obtain a key if the entry is not found in the table; sending a query comprising the obtained key to an overlay network, wherein the first node is either part of the overlay network or connected to the overlay network through a proxy or an agent; obtaining a data object associated with the key from the overlay network; and updating the table based on the data object.

According to further development or modification of the invention, said domain name in said pair of data comprises a realm of a second node that is able to provide the desired service, wherein the second node is either part of the overlay network or connected to the overlay network through a proxy or an agent and said data object comprises a fully qualified domain name of the second node.

According to one embodiment of the invention, said domain name in said pair of data comprises a fully qualified domain name of a second node that is able to provide the desired service, wherein the second node is either part of the overlay network or connected to the overlay network through a proxy or an agent and said data object comprises a realm of the second node.

Said data object may further comprises a list of application identifiers relating to the services the second node is able to provide, an IP address of the second node, geographical information of the second node and hop-by-hop security related information of the second node, wherein said list of application identifiers comprises at least one application identifier.

According to another aspect of the invention, there is provided a node for discovering another node. Said node comprises a table configured to store at least an entry relating to any service that any other node is able to provide;

a processor configured to determine if an entry relating to a desired service is found in said table, perform a hash transform to a pair of data comprising a domain name and an application identifier relating to the desired service to obtain a key if the entry is not found in the table; through a unit, send a query comprising the obtained key to an overlay network, through said unit, obtain a data object associated with the key from the overlay network; and update the table based on the data object; wherein said node being a first node and connected to the overlay network.

According to yet another aspect of the invention, there is provided a node for discovering another node. Said node comprises a table for storing at least an entry relating to any service that any other node is able to provide; a processing means for determining if an entry relating to a desired service is found in said table, performing a hash transform to a pair of data comprising a domain name and an application identifier relating to the desired service to obtain a key if the entry is not found in the table; through a unit, sending a query comprising the obtained key to an overlay network, through said unit, obtaining a data object associated with the key from the overlay network; and updating the table based on the data object; wherein said node being a first node and connected to the overlay network.

According to further development or modification of the invention, said domain name in said pair of data comprises a realm of a second node that is able to provide the desired service, wherein the second node is either part of the overlay network or connected to the overlay network through a proxy or an agent and said data object comprises a fully qualified domain name of the second node.

According to one embodiment of the invention, said domain name in said pair of data comprises a fully qualified domain name of a second node that is able to provide the desired service, wherein the second node is either part of the overlay network or connected to the overlay network through a proxy or an agent and said data object comprises a realm of the second node.

According to one embodiment of the invention, said data object further comprises a list of application identifiers relating to the services the second node is able to provide, an IP address of the second node, geographical information of the second node and hop-by-hop security related information of the second node, wherein said list of application identifiers comprises at least one application identifier.

The first node may further comprise said unit. Alternatively, the said unit may be located outside of the first node.

According to one aspect of the invention, there is provided an overlay network comprising a plurality of nodes described above, wherein each of said plurality of nodes is either a constituent node of said overlay network or connected to said overlay network through a proxy or an agent.

According to one aspect of the invention, there is provided a computer program comprising: code (or some other means) for determining if an entry relating to a desired service is found in a table stored in a first node; code (or some other means) for performing a hash transform to a pair of data comprising a domain name and an application identifier relating to the desired service to obtain a key if the entry is not found in the table; code (or some other means) for sending a query comprising the obtained key to an overlay network, wherein the first node is either part of the overlay network or connected to the overlay network through a proxy or an agent; code (or some other means) for obtaining a data object associated with the key from the overlay network; and code (or some other means) for updating the table based on the data object. The computer program may be a computer program product comprising a computer-readable medium bearing computer program code embodied therein for use with a computer.

### BRIEF DESCRIPTION OF THE DRAWINGS

FIG. 1 is an exemplary example of an overlay network.

FIG. 2 shows a schematic diagram illustrating how a Diameter node advertises its capability to an overlay network to which it connects according to one embodiment of the invention.

FIG. 3 shows a schematic diagram illustrating how a Diameter node finds another node that provides a desired service according to one embodiment of the invention.

FIG. 4 shows a schematic block diagram illustrating Diameter nodes, A and B, according to some embodiments of the invention.

FIG. 5 shows an overlay network comprising Diameter nodes and routing of query messages between the nodes.

### DESCRIPTION OF THE EMBODIMENTS OF THE INVENTION

The invention takes the advantage of overlay network which fulfils most of the requirements mentioned above.

An overlay network is a virtual network of nodes and logical links that is built on top of an existing network with the purpose to implement a network service that is not available in the existing network.

An overlay network is uniquely identified by an overlay identifier, called Overlay ID. Each overlay network is associated with a set of attributes which specify the properties of the node constituting the overlay network.

An overlay network is created by generating a unique overlay ID and by specifying the attributes of the overlay network that are associated with the overlay ID. To join an existing overlay network, a node must obtain the overlay ID and the attributes of the overlay network. The attributes of an overlay network must be known at the time when an overlay socket is created.

The overlay ID is a string that identifies an overlay network. It can be used as a key to look up the attributes of an overlay network. The overlay ID should be a globally unique identifier.

For example, many peer-to-peer networks are overlay networks because they run on top of the Internet. A peer-to-peer, commonly abbreviated to P2P, is any distributed network architecture composed of participants that make a portion of their resources (such as processing power, disk storage or network bandwidth) directly available to other network participants, without the need for central coordination instances (such as servers or stable hosts). Peers are both suppliers and consumers of resources, in contrast to the traditional client-server model where only servers supply, and clients consume.

Often, Distributed Hash Tables (DHTs) are used in an overlay network for routing messages. DHTs are a class of decentralized distributed systems that provide a lookup service similar to a hash table: (key, value) pairs are stored in the DHT, and any participating node can efficiently retrieve the value associated with a given key.

Responsibility for maintaining the mapping from keys to values is distributed among the nodes, in such a way that a change in the set of participants causes a minimal amount of disruption. This allows DHTs to scale to extremely large numbers of nodes and to handle continual node arrivals, departures, and failures. DHTs form an infrastructure that can be used to build peer-to-peer networks.

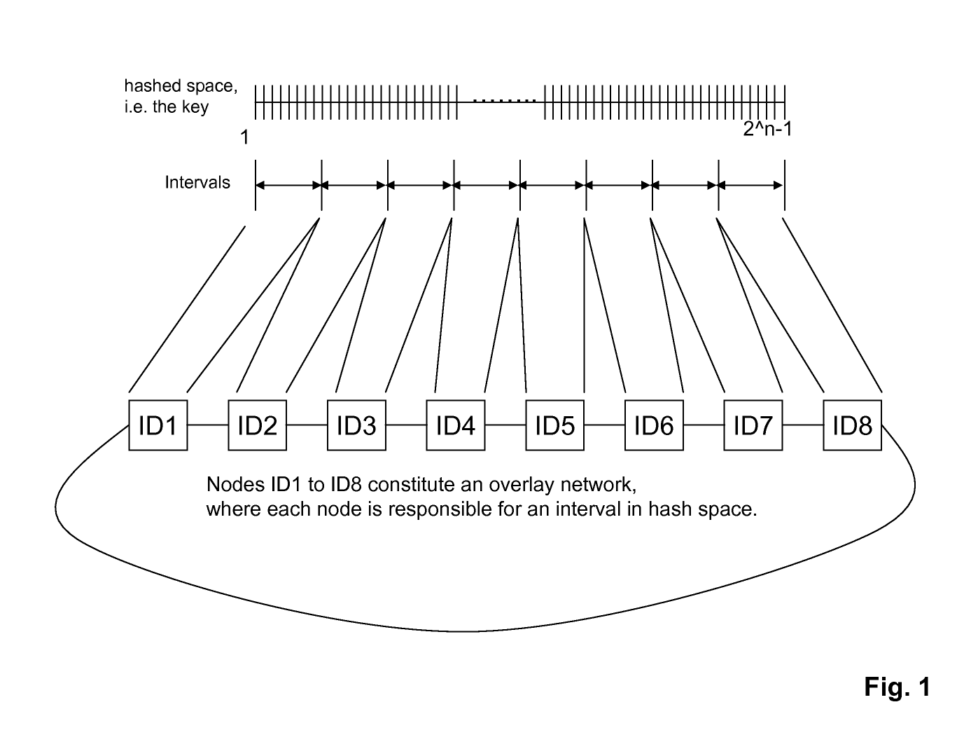

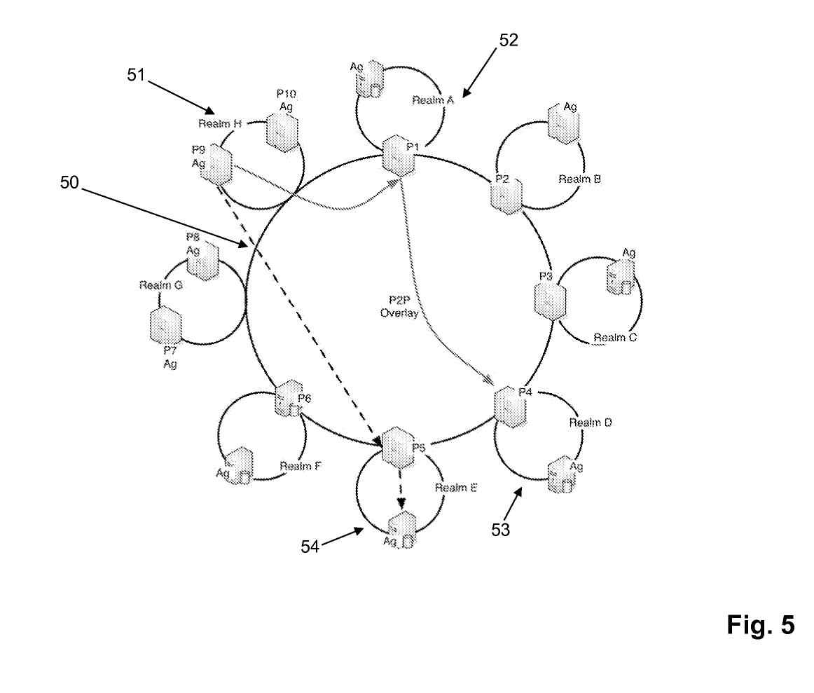

FIG. 1 is an example of overlay network. 8 nodes form an overlay network. Each constituent node (ID1 to ID8) in the overlay network is responsible for an interval in hash space. A key obtained by applying a Hash transform to an input value shall fall into one of the intervals. A node which is responsible for that interval shall provide a service. This is the basic idea of overlay network. The detailed mechanism of finding the node associated with the key will be described in FIG. 5

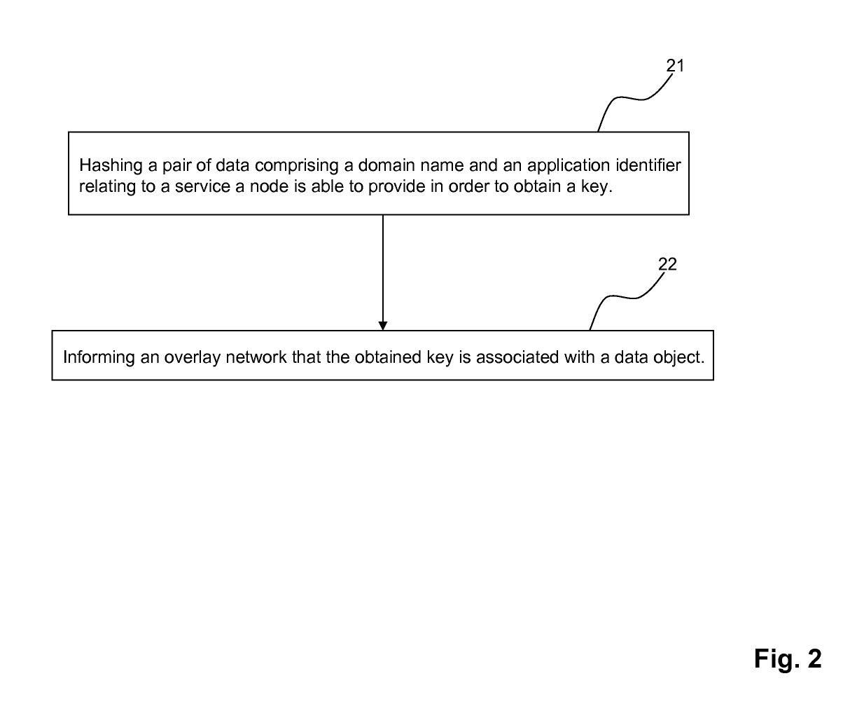

FIG. 2 shows a schematic diagram illustrating how a Diameter node advertises its capability to an overlay network to which it connects. According to one embodiment of the invention, once a Diameter node joins the overlay network, it may advertise to the overlay the service it could provide (i.e. to inform the overlay network a list of Diameter applications it may support). “Joining” an overlay may also be done through a proxy/agent. In this case, the Diameter node may communicate with the overlay network through a proxy/agent, but the Diameter node itself may not be part of the overlay network.

As depicted in step 21 in FIG. 2, the Diameter node may do Hash transform to a pair of data (i.e. realm/FQDN: application identifier) comprising a domain name of the node and an application identifier relating to a service the node is able to provide. The domain name may be either the realm (for example, company.com) where the node is located or the fully qualified domain name (FQDN) (for example, server1.company.com or server2.company.net) of the node. A key may be obtained after performing the Hash transform. Then, the Diameter node may inform the overlay network that the key is associated with a data object, i.e. (key, data object) as shown in step 22.

According to one embodiment of the invention, the domain name in the pair of data is the realm of the node. In this case, the data object may comprise a list of application identifiers relating to the services the node is able to provide, the FQDN and the IP address of the node, the geographical information of the node and the hop-by-hop security related information of the node.

With the help of geographical information of a Diameter node, it is possible to identify the Diameter node(s) located within the same region (e.g. country, state, city, or even town). So a Diameter node may take the advantage of this information to optimize the choice of routing path based on the billing scheme provided by operators, for example.

According to another embodiment of the invention, the domain name in the pair of data is the FQDN of the node. In this case, the data object may comprise a list of application identifiers relating to the services the node is able to provide, the realm and the IP address of the node, the geographical information of the node and the hop-by-hop security related information of the node.

Normally the realm of a Diameter node can be derived from the FQDN (i.e. the DiameterIdentity of the Diameter node) of the Diameter node. Both are piggybacked on the administration of the DNS namespace. Diameter makes use of the realm, also loosely refers it to as its domain. However, there is no strict rule in Diameter based protocols that the domain part of the DiameterIdentity should be equal to the realm where the Diameter node is located. The only practical requirement is that both DiameterIdentity and realm are under the same DNS administration. In other words, sometimes, the realm of a Diameter node may not be derived from the FQDN. For example, a node with FQDN (server2.company.net) may be located in the realm (company.com)

The pair (i.e. key, data object) may be stored in one of the other Diameter nodes, which is also called peer node, constituting or connecting to the overlay network. As stated before, the peer node may communicate with the overlay network through a proxy/agent, it is not mandatory that the peer node itself has to be a part of overlay network.

In this way, the overlay network is aware of the existence of a Diameter node, no matter if it joins the overlay network by itself or via a proxy/agent, and its corresponding application identifiers relating to services that the node is able to provide.

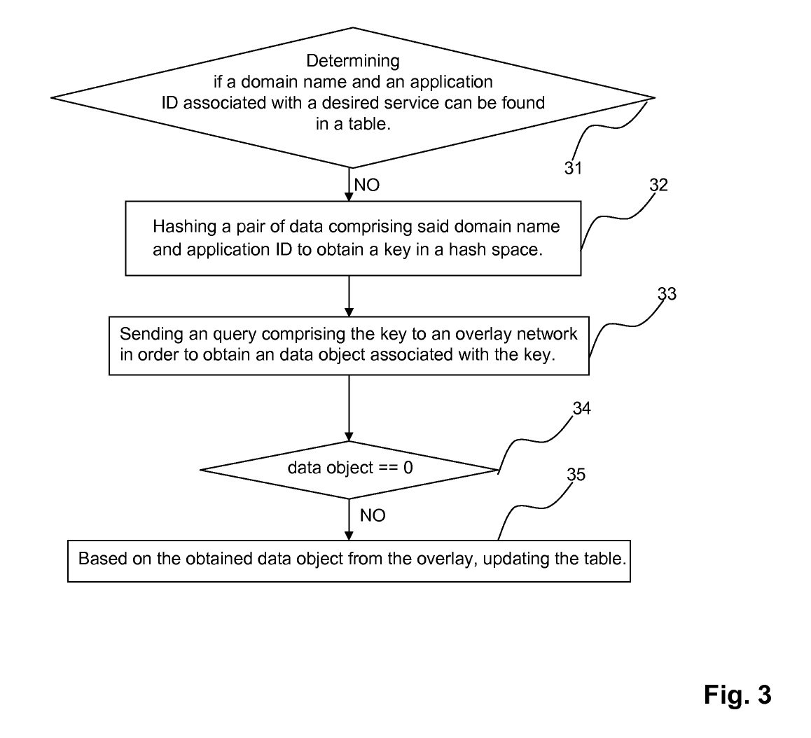

Assuming a Diameter node wants to find another Diameter node in order to obtain a desired service, FIG. 3 presents a solution according to one embodiment of the invention.

In step 31 of FIG. 3, a Diameter node may first check if an entry concerning the desired service can be found from its realm-based routing table. If no entry is found, it may do Hash transform to a pair of data comprising a domain name and an application identifier relating to the desired service (i.e. realm/FQDN: application identifier) as shown in step 32. The domain name may either be a realm or a FQDN of a node that is able to provide the desired service. A key may be obtained after performing Hash transform. The Diameter node may use the obtained key to query an overlay network, to which it is connected, in order to obtain a data object associated with the key as depicted in step 33.

The overlay network takes care of the routing of the query message automatically. The query message may travel from one node to another until it reaches a peer node storing the data object associated with the key. A detailed explanation will be given in FIG. 5 in this regard.

However, the data object may not be obtained if the key and the associated data object pair have not been stored in any of the nodes constituting or connecting to the overlay network. In this case the query to the overlay network would fail to obtain the associated data object, instead, zero data object is returned to the node sending the request, which indicates that an data object corresponding to the key does not exist. An appropriate error code (such as DIAMETER_UNABLE_TO_DELIVER, DIAMETRE_REALM_NOT_SERVED or DIAMETER_APPLICATION_UNSUPPORTED) may also be propagated to Diameter node sending the query message.

Assuming that the pair (key, data object) have been stored in the overlay network (i.e. in some node(s) constituting or connecting to the overlay network), the node sending the query message may receive the data object as shown in step 35. The data object may comprise a list of application identifiers relating to the desired service a Diameter node is able to provide, the domain name and the IP address of the node, the geographical information of the node and the hop-by-hop security related information of the node. The domain name may be either the realm or FQDN of the Diameter node providing the desired service.

Based on the obtained data object, the Diameter node sending the query message may update its realm-based routing table and also the peer table. The realm name field in realm-based routing table may be updated by the realm, either known (from the pair of data being hashed) or obtained from the data object. The

Diameter application identifier field in realm-based routing table may be updated by the application identifier already known and also by the list of application identifiers from the data object. Host identity field in peer table may be updated by the FQDN, either already known (from the pair of data being hashed) or obtained from the data object. The additional security information field in peer table may be updated by the hop-by-hop security related information obtained from the data object. The IP address and geographical information may be added to the peer table. Then, an entry in the realm-based routing table may be set up to associate with the peer table. With the updated realm-based routing table and the peer table, the node sending the query message may request the desired service from the node providing such service.

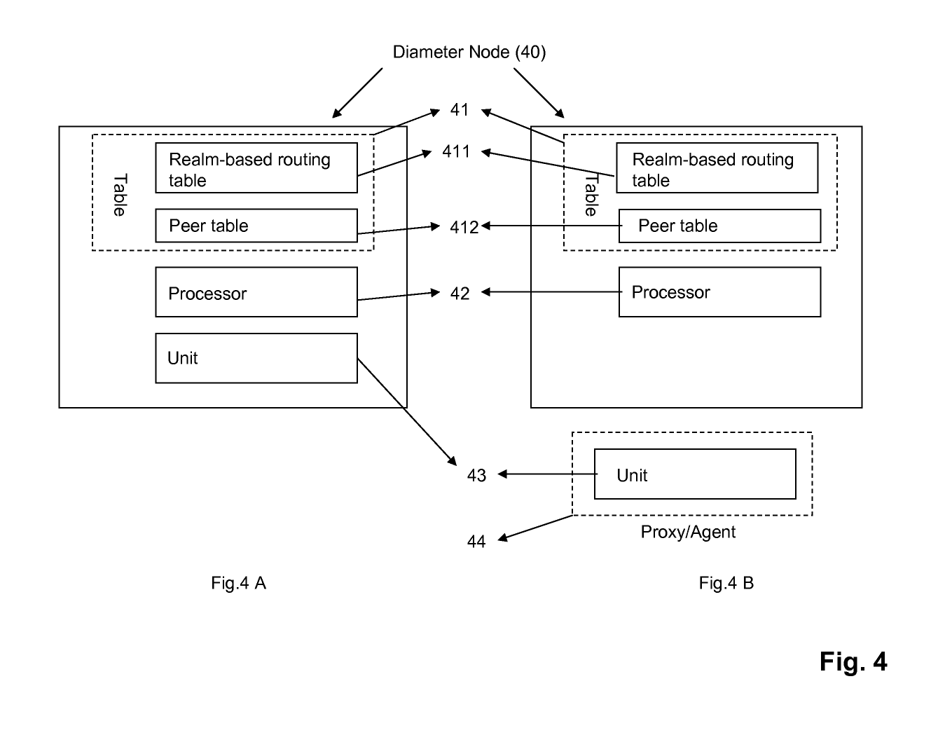

FIG. 4 shows a schematic block diagram illustrating Diameter nodes A (40) (in FIG. 4A) and B (40) (in FIG. 4B) according to some embodiments of the invention. Both of the nodes, A and B (40), comprise a processor (42) or a processing means (42) and a table (41) comprising a realm-based routing table (411) and a peer table (412).

According to one embodiment as depicted in FIG. 4A, the Diameter node A (40) further comprises a unit (43) to communicate with an overlay network (not shown in FIG. 4). The node A may be a constituent node of the overlay network.

According to another embodiment as depicted in FIG. 4B, the unit (43) that communicates with an overlay network may be located outside of the node, for example in a proxy (44) or an agent (44). In this case, the Diameter node may not be part of the overlay network. The proxy/agent (44) comprising the unit joins the overlay network instead, and all the communication between the overlay network and the node B may go through the unit (43). When the Diameter node in FIG. 4, either A or B, wants to advertise the service it could provide as being described in FIG. 2, the processor (42) may do Hash transform to a pair of data (i.e. realm/FQDN: application identifier) comprising a domain name of the node (i.e. A or B) and an application identifier relating to a service the node is able to provide (i.e. step 21 in FIG. 2). The domain name may be a realm or FQDN of the node (40). A key may be obtained after performing the Hash transform.

Through the unit (43), the processor (42) may communicate to the overlay network, to which the node (A or B) is connected, so that the node performs as a constituent node of the overlay network no matter if the node itself is part of the overlay network. The processor (42) may inform the overlay that the obtained key is associated with a data object, i.e. (key, data object) (i.e. step 22 in FIG. 2).

According to one embodiment of the invention, the domain name in the pair of data is the realm of the node (A or B) (40). In this case, the data object may comprise a list of application identifiers relating to the services the node is able to provide, the FQDN and the IP address of the node, the geographical information of the node and the hop-by-hop security related information of the node.

According to another embodiment of the invention, the domain name in the pair of data is the FQDN of the node (A or B) (40). In this case, the data object may comprise a list of application identifiers relating to the services the node is able to provide, the realm and the IP address of the node, the geographical information of the node and the hop-by-hop security related information of the node.

When the node, either A or B (40), in FIG. 4 wants to find another Diameter node (not shown in FIG. 4) for a desired service, the processor (42) may first check if an entry concerning the desired service can be found from its realm-based table (411). If no entry is found, it may do Hash transform to a pair of data (i.e. realm/FQDN: application identifier) comprising the domain name and the application identifier relating to the desired service. The domain name may either be a realm or a FQDN of a node that is able to provide the desired service. A key may be obtained after performing Hash transform. Through the unit, the processor may use the obtained key to query the overlay network for a data object associated with the key.

If the requested data object is available from the overlay network, it may also be received by the processor (42) through the unit (43).

The data object may comprise a list of application identifiers relating to the desired services another node is able to provide, the domain name and the IP address of the node, the geographical information of the node, and the hop-by-hop security related information of the node. The domain name may be either the realm or FQDN of the node.

According to one embodiment of the invention, the domain name in the pair of data is the realm of the node that is able to provide the desired service. In this case, the data object may comprise a list of application identifiers relating to the services the node is able to provide, the FQDN and the IP address of the node, the geographical information of the node and the hop-by-hop security related information of the node.

According to another embodiment of the invention, the domain name in the pair of data is the FQDN of the node that is able to provide the desired service. In this case, the data object may comprise a list of application identifiers relating to the services the node is able to provide, the realm and the IP address of the node, the geographical information of the node and the hop-by-hop security related information of the node.

Based on the obtained data object, the processor (42) may update its realm-based routing table (411) and peer table (412).

The realm name field in realm-based routing table may be updated by the realm, either known (from the pair of data being hashed) or obtained from the data object. The Diameter application identifier field in realm-based routing table may be updated by the application identifier already known and also the list of application identifiers from the data object. Host identity field in peer table may be updated by the FQDN, either already known (from the pair of data being hashed) or obtained from the data object. The additional security information field in peer table may be updated by the hop-by-hop security related information obtained from the data object. The IP address and geographical information may be added to the peer table.

Then, the processor (42) may set up an entry in the realm-based routing table so as to associate with the peer table. With the updated realm-based routing table and the peer table, the processor may request the desired service from the node that is able to provide such service.

However, as stated before, it is not mandatory that every Diameter node has to join the overlay network. Some Diameter nodes, especially those that act as “clients” or “servers” deep in operator's core network may just use the information available in the overlay network through some local relay/proxy agent which is part of the overlay. The intention is that not all Diameter nodes have to be upgraded to be aware of overlay network. The nodes A and B illustrate these two arrangements.

FIG. 5 shows the basic architecture and implementation according to one embodiment of the invention. In the example, Diameter nodes named with “P” such as P1 and P9 are constituent nodes of an overlay network (50). Node named with “Ag” is normal Diameter node. According to one embodiment of the invention, in Realm A (52), an edge node P1 (also called proxy/agent) serves as a gateway to facilitate the communication between a Diameter node Ag and the overlay network (50). P1 itself is part of the overlay network. In other words, Diameter node Ag in Realm A (52) “joins” the overlay network (50) via the edge node P1.

Yet, according to another embodiment of the invention, Realm H (51) does not have an edge node. A Diameter node Ag in Realm H (51) may also be part of the overlay, and thus it is also called P9.

Upon joining the overlay network (50), each Diameter node may advertise service it may provide and the corresponding Diameter application identifier if any as being described in FIG. 2. The pair (key, data object) may be stored in one of the other Diameter nodes constituting or connecting to the overlay network (50).

Let's assume, P9 wants to request a desired service from a Diameter node in Realm E (54). If the Ag/P9 can find an entry in its realm-based routing table regarding the desired service, it may contact the node Ag in Realm E (54) via P5 directly as indicated by the dotted line.

However, if no entry is found, Ag/P9 may perform Hash transform to a pair of data comprising a domain name (in this case, it can be the realm of Realm E (54)) and an application identifier associated with the desired service (i.e. step 32 in FIG. 3). A key may be obtained after doing the Hash transform. Then Ag/P9 may use the key to query the overlay network in order to obtain a data object as being described in step 33 of FIG. 3.

The overlay network takes care of the query message automatically. In the example illustrated in FIG. 5, the query message may travel to Realm A (52) first. Through the edge node P1 in Realm A (52), the Diameter node Ag may receive the query message and forward it to Realm D (53) because it is not aware of the key contained in the query message.

Through the edge node P4 in Realm D (53), the Diameter node Ag in Realm D (53) may receive the forwarded query message. Assuming the Diameter node Ag in Realm D (53) is aware of the key, it may provide the data object associated with the key and send it back to the Diameter node Ag in Realm A (52). Upon receiving the data object, the Diameter node Ag in Realm A may forward it to the node Ag/P9 in Realm H (51).

Based on the received data object, Ag/P9 in Realm H (51) may update its realm-based routing table (411) and peer table (412). Then it may contact in the node Ag in Realm E (54) via P5 directly as indicated by the dotted line to request the desired service.

Only the servers directly connected to the overlay network need to be upgraded to be overlay compatible. Others may still be legacy Diameter nodes and communicate with overlay network via proxy/agent.

As the matter of fact, the realm/ FQDN+application is the fundamental information where the Diameter AAA routing is based. The invention fulfils the requirements for Diameter servers mentioned above and with the advantages that there is no need to rely on centralized DNS infrastructure for discovering Diameter peers. The overlay network is typically resilient to changes (e.g. nodes joining and leaving the network) and does not need centralized management. Thus it is much easier to implement and administrate than any DNS-based system.

Moreover, the invention also provides other useful information such as geographical location that can be used to select a closer peer server if several responses are received.

Another advantage of overlay network is that it can be deployed internally within a realm and that network does not need to be visible to the global roaming infrastructure.

For the purpose of the present invention as described above, it should be noted that
although Diameter node has been used as an example in most of the embodiments when describing the invention, it should be understood that the invention is not limited to Diameter node. It may also be applied to any other node wherever feasible for a skilled person in the art.
method steps likely to be implemented as software code portions and being run using a processor at one of the server entities are software code independent and can be specified using any known or future developed programming language;
method steps and/or devices likely to be implemented as hardware components at one of the server entities are hardware independent and can be implemented using any known or future developed hardware technology or any hybrids of these, such as MOS, CMOS, BiCMOS, ECL, TTL, etc, using for example ASIC components or DSP components, as an example;
generally, any method step is suitable to be implemented as software or by hardware without changing the idea of the present invention;
devices can be implemented as individual devices, but this does not exclude that they are implemented in a distributed fashion throughout the system, as long as the functionality of the device is preserved.

It is to be understood that the above description is illustrative of the invention and is not to be construed as limiting the invention. Various modifications and applications may occur to those skilled in the art without departing from the true spirit and scope of the invention as defined by the appended claims.

1. A method for node discovery comprising
determining if an entry relating to a desired service is found in a table stored in a first node;
performing a hash transform to a pair of data comprising a domain name and an application identifier relating to the desired service to obtain a key if the entry is not found in the table;
sending a query comprising the obtained key to an overlay network, wherein the first node is either part of the overlay network or connected to the overlay network through a proxy or an agent;
obtaining a data object associated with the key from the overlay network; and
updating the table based on the data object.

2. The method according to claim 1, wherein said domain name in said pair of data comprises a realm of a second node that is able to provide the desired service, wherein the second node is either part of the overlay network or connected to the overlay network through a proxy or an agent.

3. The method according claim 2, wherein said data object comprises a fully qualified domain name of the second node.

4. The method according to claim 1, wherein said domain name in said pair of data comprises a fully qualified domain name of a second node that is able to provide the desired service, wherein the second node is either part of the overlay network or connected to the overlay network through a proxy or an agent.

5. The method according to claim 4, wherein said data object comprises a realm of the second node.

6. The method according to claim 2, wherein said data object further comprises a list of application identifiers relating to the services the second node is able to provide, an IP address of the second node, geographical information of the second node and hop-by-hop security related information of the second node, wherein said list of application identifiers comprises at least one application identifier.

7. A node for discovering another node comprising
a table configured to store at least an entry relating to any service that any other node is able to provide;
a processor configured to
determine if an entry relating to a desired service is found in said table,
perform a hash transform to a pair of data comprising a domain name and an application identifier relating to the desired service to obtain a key if the entry is not found in the table; through a unit, send a query comprising the obtained key to an overlay network, through said unit, obtain a data object associated with the key from the overlay network; and
update the table based on the data object;
wherein said node being a first node and connected to the overlay network.

8. The node according to claim 7, wherein said domain name in said pair of data comprises a realm of a second node that is able to provide the desired service, wherein the second node is either part of the overlay network or connected to the overlay network through a proxy or an agent.

9. The node according to claim 8, wherein said data object comprises a fully qualified domain name of the second node.

10. The node according to claim 7, wherein said domain name in said pair of data comprises a fully qualified domain name of a second node that is able to provide the desired service, wherein the second node is either part of the overlay network or connected to the overlay network through a proxy or an agent.

11. The node according to claim 10, wherein said data object comprises a realm of the second node.

12. The node according to claim 9 wherein said data object further comprises a list of application identifiers relating to the services the second node is able to provide, an IP address of the second node, geographical information of the second node and hop-by-hop security related information of the second node, wherein said list of application identifiers comprises at least one application identifier.

13. The node according claim 7, wherein the first node either further comprises said unit or said unit is located outside of the first node.

14. An overlay network comprising a plurality of nodes according claim 7, wherein each of said plurality of nodes is either a constituent node of said overlay network or connected to said overlay network through a proxy or an agent.

15. A computer program product comprising:
means for determining if an entry relating to a desired service is found in a table stored in a first node;
means for performing a hash transform to a pair of data comprising a domain name and an application identifier relating to the desired service to obtain a key if the entry is not found in the table;
means for sending a query comprising the obtained key to an overlay network, wherein the first node is either part of the overlay network or connected to the overlay network through a proxy or an agent;
means for obtaining a data object associated with the key from the overlay network; and
means for updating the table based on the data object.
